(19) United States
(12) Patent Application Publication
(10) Pub. No.: US 2013/0049727 A1
(43) Pub. Date: Feb. 28, 2013

(54) CONSTANT VOLTAGE POWER CIRCUIT AND SEMICONDUCTOR INTEGRATED CIRCUIT

(71) Applicants: Atsushi NAMAI, Kawasaki-shi (JP); Hironori Nagasawa, Yokohama-shi (JP)

(72) Inventors: Atsushi NAMAI, Kawasaki-shi (JP); Hironori Nagasawa, Yokohama-shi (JP)

(73) Assignee: KABUSHIKI KAISHA TOSHIBA, TOKYO (JP)

(21) Appl. No.: 13/424,488

(22) Filed: Mar. 20, 2012

(30) Foreign Application Priority Data
Aug. 31, 2011 (JP) 2011-189692

(51) Int. Cl. G05F 3/02

(52) U.S. Cl. 323/304

(57) ABSTRACT

According to one embodiment, a constant voltage power circuit includes a bias generator, a reference voltage generator, and a constant voltage generator, a bias switch, a constant voltage controller. The bias generator generates a first bias voltage. The reference voltage generator is connected to the bias generator and generates a reference voltage. The constant voltage generator generates a constant voltage. The bias switch switches a bias supplied to the constant voltage generator in accordance with a switch control signal controlling the bias switch. The constant voltage controller obtains a detected voltage corresponding to the constant voltage or a power supply voltage, and generates a constant voltage control signal and the switch control signal. The constant voltage control signal sets an operating state of the constant voltage generator to an enable state or a disable state.

### CROSS REFERENCE TO RELATED APPLICATION(S)

This application is based upon and claims the benefit of priority from the prior Japanese Patent Application No. 2011-189692, filed on Aug. 31, 2011, the entire contents of which are incorporated herein by reference.

### FIELD

Embodiments described herein relate generally to a constant voltage power circuit and a semiconductor integrated circuit.

### BACKGROUND

Generally, for supplying a constant voltage to a load that operates at a predetermined voltage, a constant voltage power circuit is used. A conventional constant voltage power circuit includes a bias generating circuit, a reference voltage generating circuit, a constant voltage generating circuit, and a constant voltage controlling circuit.

The bias generating circuit generates a bias voltage. The reference voltage generating circuit generates a reference voltage using the bias voltage. The constant voltage generating circuit generates the constant voltage to be supplied to the load using the bias voltage and the reference voltage. The constant voltage controlling circuit monitors a monitor voltage corresponding to a power supply voltage, and generates a control signal that puts the constant voltage generating circuit into an enable state or a disable state according to a difference between the monitor voltage and the reference voltage. The constant voltage generating circuit generates the constant voltage in the enable state and stops an operation thereof in the disable state.

However, in the conventional constant voltage power circuit, the bias voltage is supplied to the constant voltage generating circuit even if the constant voltage generating circuit becomes the disable state. Accordingly, a current is passed through the constant voltage generating circuit according to the bias voltage. As a result, the constant voltage power circuit consumes a useless electric power.

Moreover, in the conventional constant voltage power circuit, the reference voltage varies when the bias voltage is set to zero in order to stop the current flowing through the constant voltage generating circuit in the disable state. When the reference voltage varies, the constant voltage controlling circuit may be unable to generate the control signal that puts the constant voltage generating circuit into the disable state, because the output of the constant voltage controlling circuit depends on the reference voltage. As a result, the operation of the constant voltage power circuit becomes malfunctions.

### BRIEF DESCRIPTION OF THE DRAWINGS

FIG. 1 is a block diagram illustrating a configuration of the constant voltage power circuit 10 of the first embodiment.

FIG. 2 is a block diagram illustrating the configuration of the constant voltage controller 15 in FIG. 1 of the first embodiment.

FIG. 3 is a table illustrating the signal levels of the constant voltage control signal CCV, and first and second switch control signals SW1 and SW2 of the first embodiment.

FIG. 4 is a block diagram illustrating a configuration of the constant voltage controller 15 in FIG. 1 of the second embodiment.

FIGS. 5A to 5C are schematic diagrams illustrating configuration examples of a delay circuit 154 in FIG. 4 of the second embodiment.

FIG. 6 is a table illustrating the signal levels of the constant voltage control signal CCV, and first and second switch control signals SW1 and SW2 of the second embodiment.

FIG. 7 is a timing chart illustrating the timings of the signals Na and Nb, and first and second switch control signals SW1 and SW2 of the second embodiment.

FIG. 8 is a block diagram illustrating a configuration of the constant voltage power circuit 10 of the third embodiment.

FIG. 9 is a block diagram illustrating the configuration of the constant voltage controller 15 in FIG. 8 of the third embodiment.

FIG. 10 is a table illustrating the signal levels of the power control signal PCS, constant voltage control signal CCV, first and second switch control signals SW1 and SW2, and operating mode switch control signal SW3 of the third embodiment.

FIG. 11 is a block diagram illustrating the configuration of a constant voltage controller 15 in FIG. 8 of the fourth embodiment.

FIG. 12 is a table illustrating the signal levels of the power control signal PCS, constant voltage control signal CCV, first and second switch control signal SW1 and SW2, and operating mode switch control signal SW3 of the fourth embodiment.

FIG. 13 is a block diagram illustrating a configuration of the semiconductor integrated circuit 1 of the fifth embodiment.

### DETAILED DESCRIPTION

Embodiments will now be explained with reference to the accompanying drawings.

In general, according to one embodiment, a constant voltage power circuit includes a bias generator, a reference voltage generator, a constant voltage generator, a bias switch, and a constant voltage controller. The bias generator generates a first bias voltage. The reference voltage generator is connected to the bias generator and generates a reference voltage based on the first bias voltage. The constant voltage generator generates a constant voltage based on the first bias voltage and the reference voltage. The bias switch switches a bias supplied to the constant voltage generator in accordance with a switch control signal controlling the bias switch. The constant voltage controller obtains a detected voltage corresponding to the constant voltage or a power supply voltage, and generates a constant voltage control signal and the switch control signal in accordance with a difference between the reference voltage and the detected voltage. The constant voltage control signal sets an operating state of the constant voltage generator to an enable state or a disable state.

### First Embodiment

A first embodiment will be described below. In the first embodiment, an example in which a bias supplied to a constant voltage generator is switched using an inverter is explained.

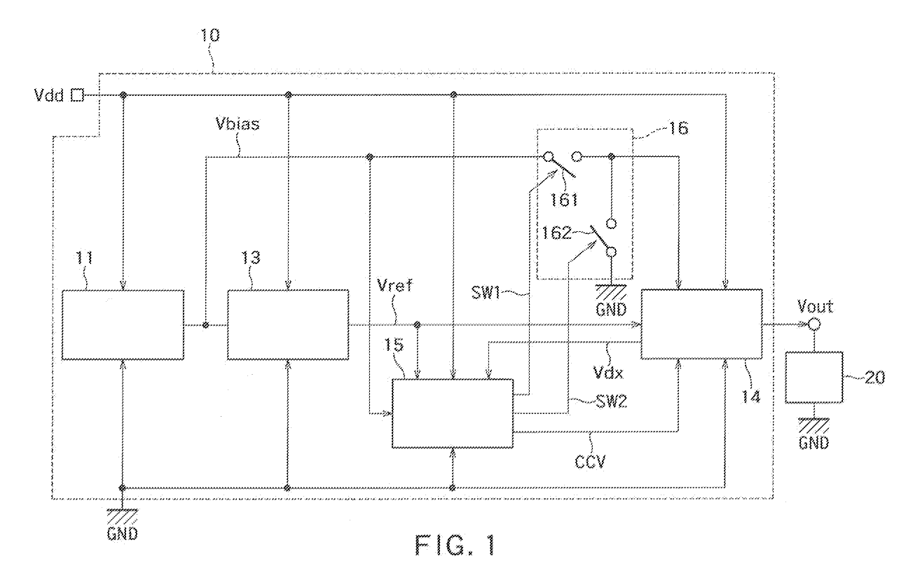

A constant voltage power circuit 10 of the first embodiment will be described. FIG. 1 is a block diagram illustrating a configuration of the constant voltage power circuit 10 of the first embodiment.

The constant voltage power circuit 10 includes units such as a bias generator 11, a reference voltage generator 13, a constant voltage generator 14, a constant voltage controller 15, and a bias switch 16. A power supply voltage Vdd that provides a power supply potential is supplied to each unit, and a ground GND that provides a ground potential is connected to each unit. A load 20 is connected to an output terminal (that is, an output terminal of the constant voltage generator 14) of the constant voltage power circuit 10.

The bias generator 11 generates a bias voltage (first bias voltage) Vbias to be supplied to the reference voltage generator 13, the constant voltage generator 14, and the constant voltage controller 15.

The reference voltage generator 13 is connected to the bias generator 11 and generates a reference voltage Vref based on the bias voltage Vbias.

The constant voltage generator 14 generates a constant voltage Vout based on the bias voltage Vbias and the reference voltage Vref.

The bias switch 16 switches a bias supplied to the constant voltage generator 14 in accordance with a switch control signal generated by the constant voltage controller 15. For example, the bias switch 16 includes a first bias switch 161 and a second bias switch 162. The first bias switch 161 switches a conduction state and a non-conduction state of a line between the bias generator 11 and a bias terminal of the constant voltage generator 14 (that is, whether the bias voltage Vbias is supplied to the constant voltage generator 14). The second bias switch 162 switches the conduction state and the non-conduction state of a line between the ground GND and the bias terminal of the constant voltage generator 14.

The constant voltage controller 15 obtains a detected voltage Vdx corresponding to the constant voltage Vout or the power supply voltage Vdd. The detected voltage Vdx has a voltage value in which the constant voltage Vout or the power supply voltage Vdd is divided at a predetermined rate. For example, the voltage value of the detected voltage Vdx is a voltage value (Vout/2) in which the constant voltage Vout is divided into two or a voltage value (Vdd/2) in which the power supply voltage Vdd is divided into two.

Moreover, the constant voltage controller 15 generates a constant voltage control signal CCV (EN) that sets an operating state of the constant voltage generator 14 to the enable state or the disable state in accordance with a difference between the reference voltage Vref and the detected voltage Vdx. For example, the constant voltage controller 15 generates the constant voltage control signal CCV (EN) that sets the operating state of the constant voltage generator 14 to the enable state when the reference voltage Vref is lower than the detected voltage Vdx, and the constant voltage controller 15 generates the constant voltage control signal CCV (DIS) that sets the operating state to the disable state when the reference voltage Vref is equal to or higher than the detected voltage Vdx. At this point, the constant voltage generator 14 generates the constant voltage Vout in the enable state (that is, when the constant voltage control signal CCV (EN) is generated), and the constant voltage generator 14 does not generate the constant voltage Vout in the disable state (that is, when the constant voltage control signal CCV (DIS) is generated).

Moreover, the constant voltage controller 15 generates a switch control signal that controls the bias switch 16 in accordance with the difference between the reference voltage Vref and the detected voltage Vdx.

For example, when the reference voltage Vref is lower than the detected voltage Vdx, the constant voltage controller 15 generates a first switch control signal SW1 (ON) that turns on the first bias switch 161 and a second switch control signal SW2 (OFF) that turns off the second bias switch 162. That is, when the reference voltage Vref is lower than the detected voltage Vdx, the constant voltage controller 15 generates the first switch control signal SW1 (ON) and the second switch control signal SW2 (QFF) that connect the constant voltage generator 14 to the bias generator 11.

On the other hand, when the reference voltage Vref is equal to or higher than the detected voltage Vdx, the constant voltage controller 15 generates the first switch control signal SW1 (OFF) that turns off the first bias switch 161 and the second switch control signal SW2 (ON) that turns on the second bias switch 162. That is, when the reference voltage Vref is equal to or higher than the detected voltage Vdx, the constant voltage controller 15 generates the first switch control signal SW1 (OFF) and the second switch control signal SW2 (ON) that supply a shut down voltage (second bias voltage) to the constant voltage generator 14 (for example, connects the constant voltage generator 14 to the ground GND). This shut down voltage can shut down the constant voltage generator 14.

When the reference voltage Vref is lower than the detected voltage Vdx, the bias switch 16 uses the first switch control signal SW1 (ON) and the second switch control signal SW2 (OFF) to set the line between the bias generator 11 and the bias terminal of the constant voltage generator 14 to the conduction state and to set the line between the ground GND and the bias terminal of the constant voltage generator 14 to the non-conduction state. As a result, the bias voltage Vbias is supplied to the constant voltage generator 14. The constant voltage generator 14 then generates the constant voltage Vout corresponding to the difference between the reference voltage Vref and the bias voltage Vbias.

On the other hand, when the reference voltage Vref is equal to or higher than the detected voltage Vdx, the bias switch 16 uses the first switch control signal SW1 (OFF) and the second switch control signal SW2 (ON) to set the line between the bias generator 11 and the bias terminal of the constant voltage generator 14 to the non-conduction state and to set the line between the ground GND and the bias terminal of the constant voltage generator 14 to the conduction state. As a result, the bias voltage Vbias is not supplied to the constant voltage generator 14 as well as the constant voltage generator 14 is shut down. Accordingly, power consumption of the constant voltage generator 14 in the disable state is lower than that of the constant voltage generator 14 in the enable state.

At this point, even if the first switch control signal SW1 (OFF) and the second switch control signal SW2 (ON) are generated, the line between the bias generator 11 and the reference voltage generator 13 and the line between the bias generator 11 and the constant, voltage controller 15 are in the conduction state, so a malfunction of the constant voltage controller 15 can be prevented.

Incidentally, when the reference voltage Vref is equal to or lower than detected voltage Vdx, the constant voltage controller 15 may generate the constant voltage control signal CCV (EN) that sets the operating state to the enable state, and generate the first switch control signal SW1 (ON) and second switch control signal SW2 (OFF) that connect the bias terminal of the constant voltage generator 14 to the bias generator 11. When the reference voltage Vref is higher than the detected voltage Vdx, the constant voltage controller 15 may generate the constant voltage control signal CCV (DIS) that sets the operating state to the disable state, and generate the first switch control signal SW1 (OFF) and second switch control signal SW2 (ON) that supply the shut down voltage to the constant voltage generator 14 (for example, connect the constant voltage generator 14 to the ground GND).

That is, when the reference voltage Vref is equal to the detected voltage Vdx, the constant voltage controller 15 may generate the first switch control signal SW1 and second switch control signal SW2 that supply the shut down voltage to the constant voltage generator 14, or generate the first switch control signal SW1 and second switch control signal SW2 that supply the bias voltage Vbias to the constant voltage generator 14.

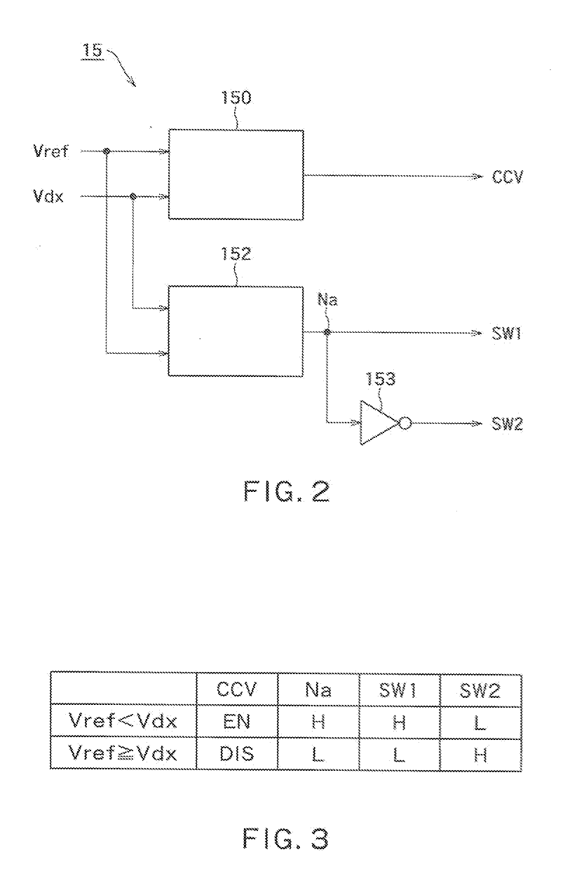

A configuration of the constant voltage controller 15 of the first embodiment will be described. FIG. 2 is a block diagram illustrating the configuration of the constant voltage controller 15 in FIG. 1 of the first embodiment.

The constant voltage controller 15 includes a control signal generator 150, a bias controller 152, and an inverter 153.

The control signal generator 150 compares the reference voltage Vref and the detected voltage Vdx, and generates the constant voltage control signal CCV corresponding to the difference between the reference voltage Vref and the detected voltage Vdx.

The bias controller 152 compares the reference voltage Vref and the detected voltage Vdx, and generates a signal Na having a signal level corresponding to the difference between reference voltage Vref and the detected voltage Vdx.

The inverter 153 inverts the signal level of the signal Na (that is, an output of the bias controller 152). That is, the signal level (first signal level) of the first switch control signal SW1 is equal to that of the signal Na, whereas the signal level (second signal level) of the second switch control signal SW2 is inverse of that of the signal Na (that is, that of the signal level of the first switch control signal SW1).

The signal levels of the constant voltage control signal CCV, and first and second switch control signals SW1 and SW2 of the first embodiment will be described. FIG. 3 is a table illustrating the signal levels of the constant voltage control signal CCV, and first and second switch control signals SW1 and SW2 of the first embodiment.

When the reference voltage Vref is lower than the detected voltage Vdx, the constant voltage control signal CCV (EN) is generated, the signal levels of the signal Na and first switch control signal SW1 become high (H), and the signal level of the second switch control signal SW2 becomes low (L). That is, the first switch control signal SW1 (ON) and the second switch control signal SW2 (OFF) are generated. In this case, since the bias generator 11 is connected to the constant voltage generator 14 by the first bias switch 161, the bias voltage Vbias is supplied.

On the other hand, when the reference voltage Vref is equal to or higher than the detected voltage Vdx, the constant voltage control signal CCV (DIS) is generated, the signal levels of the signal Na and first switch control signal SW1 become low (L), and the signal level of the second switch control signal SW2 becomes high (H). That is, the first switch control signal SW1 (OFF) and the second switch control signal SW2 (ON) are generated. In this case, since the ground GND is connected to the constant voltage generator 14 by the second bias switch 162, the bias voltage Vbias is not supplied.

According to the first embodiment, the constant voltage controller 15 controls the bias switch 16 such that the bias voltage Vbias is supplied to the constant voltage generator 14 when the reference voltage Vref is lower than the detected voltage Vdx and such that the bias voltage Vbias is not supplied to the constant voltage generator 14 as well as the constant voltage generator 14 is shut down when the reference voltage Vref is equal to or higher than the detected voltage Vdx. Therefore, the power consumption of the constant voltage power circuit 10 can be reduced while the constant voltage power circuit 10 keeps normal functions.

### Second Embodiment

A second embodiment will be described below. In the second embodiment, an example in which a through-current flowing through the constant voltage controller under a given condition is prevented is explained. The substantially same description as the embodiment is omitted. Particularly, a configuration of a constant voltage power circuit 10 of the second embodiment is substantially identical to that of the first embodiment.

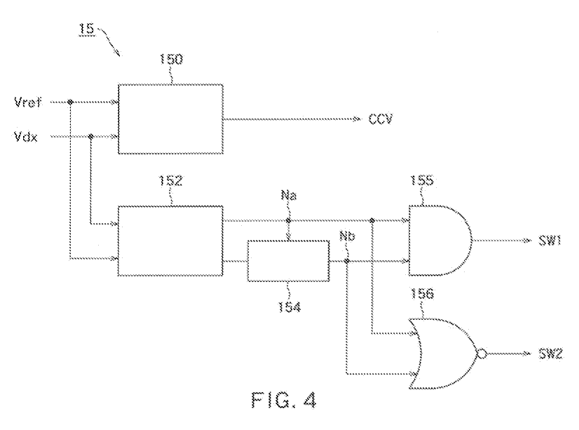

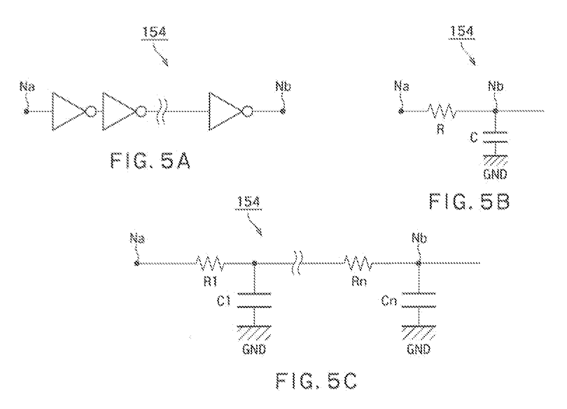

A configuration of a constant voltage controller 15 of the second embodiment will be described. FIG. 4 is a block diagram illustrating a configuration of the constant voltage controller 15 in FIG. 1 of the second embodiment. FIGS. 5A to 5C are schematic diagrams illustrating configuration examples of a delay circuit 154 in FIG. 4 of the second embodiment.

The constant voltage controller 15 includes the delay circuit 154 and a combination of logic gates (an AND gate 155 and a NOR gate 156) in addition to the similar configuration to the first embodiment (that is a control signal generator 150 and a bias controller 152).

The delay circuit 154 delays the signal Na (that is, the output of the bias controller 152) by a predetermined delay time □t. The AND gate 155 performs an AND operation of the signal Na and a signal Nb (that is, an output of the delay circuit 154). An output of the AND gate 155 is the first switch control signal SW1. The NOR gate 156 performs a NOR operation of the signals Na and Nb. An output of the NOR gate 156 is the second switch control signal SW2.

For example, the delay circuit 154 may include even number of inverters as illustrated in FIG. 5A, or include at least one stage of an RC circuit (that is, single-stage of an RC ladder type circuit as illustrated in FIG. 5B or multiple-stage of RC ladder type circuits as illustrated in FIG. 5C). In the case of FIG. 5C, resistance values of resistors R1 to Rn (n is an integer of 2 to N (N is an integer of 2 or more)) may be equal to or different from one another. Capacitances of capacitors C1 to Cn may be equal to or different from one another.

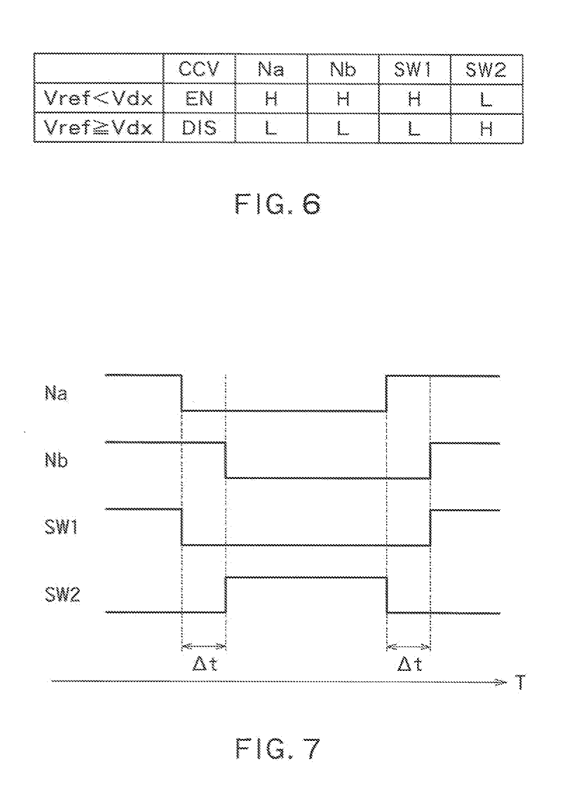

The signal levels of the constant voltage control signal CCV, and first and second switch control signals SW1 and SW2 of the second embodiment will be described below. FIG. 6 is a table illustrating the signal levels of the constant voltage control signal CCV, and first and second switch control signals SW1 and SW2 of the second embodiment.

When the reference voltage Vref is lower than the detected voltage Vdx, the constant voltage control signal CCV (EN) is generated, the signal levels of signals Na and Nb and first switch control signal SW1 become high (H), and the signal level of the second switch control signal SW2 becomes low (L). As a result, similarly to the first embodiment, the first switch control signal SW1 (ON) and the second switch control signal SW2 (OFF) are generated. In this case, since a bias generator 11 is connected to a constant voltage generator 14 by a first bias switch 161, the bias voltage Vbias is supplied to the constant voltage generator 14.

On the other hand, when the reference voltage Vref is equal to or higher than the detected voltage Vdx, the constant voltage control signal CCV (DIS) is generated. The signal levels of the signals Na and Nb and first switch control signal SW1 become low (L), and the signal level of the second switch control signal SW2 becomes high (H). As a result, similarly to the first embodiment, the first switch control signal SW1 (OFF) and the second switch control signal SW2 (ON) are generated. In this case, since the ground GND is connected to the constant voltage generator 14 by a second bias switch 162, the bias voltage Vbias is not supplied.

Timings of the constant voltage control signal CCV, and first and switch control signals SW1 and SW2 of the second embodiment will be described below. FIG. 7 is a timing chart illustrating the timings of the signals Na and Nb, and first and second switch control signals SW1 and SW2 of the second embodiment.

The signal Nb is delayed by the delay time Δt with respect to the signal Na. The signal level of the first switch control signal SW1 changes from high (H) to low (L) at a falling edge of the signal Na, and changes from low (L) to high (H) at a rising edge of the signal Nb. The signal level of the second switch control signal SW2 changes from low (L) to high (H) at the falling edge of the signal Nb, and changes from high (H) to low (L) at the rising edge of the signal Na.

Accordingly, after the delay time Δt elapses since the signal level of the first switch control signal SW1 changes from high (H) to low (L), the signal level of the second switch control signal SW2 changes from low (L) to high (H). This means that the second bias switch 162 is turned on (that is, the constant voltage generator 14 is connected to the ground GND) after the first bias switch 161 is turned off (that is, after the constant voltage generator 14 is separated from the bias generator 11). In other words, when changing the operating state from the enable state to the disable state, the constant voltage controller 15 generates the first and second switch control signals SW1 and SW2 such that the shut down voltage is supplied to the constant voltage generator 14 after cutting off the supply of the bias voltage Vbias to the constant voltage generator 14.

Moreover, after the delay time Δt elapses since the signal level of the second switch control signal SW2 changes from high (H) to low (L), the signal level of the first switch control signal SW1 changes from low (L) to high (H). This means that the first bias switch 161 is turned on (that is, the constant voltage generator 14 is connected to the bias generator 11) after the second bias switch 162 is turned off (that is, after the constant voltage generator 14 is separated from the ground GND). In other words, when changing the operating state from the disable state to the enable state, the constant voltage controller 15 generates the first and second switch control signals SW1 and SW2 such that the bias voltage Vbias is supplied to the constant voltage generator 14 after cutting off the supply of the shut down voltage to the constant voltage generator 14.

If one of the first and second bias switches 161 and 162 is tuned on before the other is turned off, the through-current may flow through the constant voltage generator 14.

In contras, according to the second embodiment, the constant voltage controller 15 generates the first and second switch control signals SW1 and SW2 such that one of the first and second bias switches 161 and 162 is turned on after the other is turned off. Therefore, it can be prevented that the through-current flows through the constant voltage generator 14.

### Third Embodiment

A third embodiment will be described below. In the third embodiment, an example in which the power consumption of the constant voltage power circuit is further reduced than that of the first embodiment. The substantially same description as the embodiment is omitted.

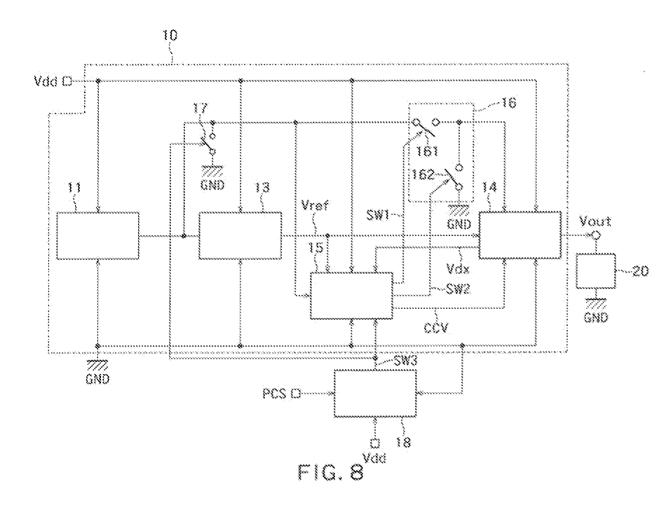

A constant voltage power circuit 10 of the third embodiment will be described below. FIG. 8 is a block diagram illustrating a configuration of the constant voltage power circuit 10 of the third embodiment.

The constant voltage power circuit 10 includes an operating mode controller 18 and an operating mode switch 17 in addition to the similar configuration to the first embodiment (that is, a bias generator 11, a reference voltage generator 13, a constant voltage generator 14, a constant voltage controller 15, and a bias switch 16). The power supply voltage Vdd is supplied to the operating mode controller 18, and the ground GND is connected to the operating mode controller 18. A load 20 is connected to the output terminal (that is, the output terminal of the constant voltage generator 14) of the constant voltage power circuit 10.

A power control signal PCS, which is generated by a power manager outside of the constant voltage power circuit 10, is supplied to the operating mode controller 18. The power control signal PCS is a signal that sets the operating modes of the bias generator 11, reference voltage generator 13, constant voltage generator 14, and constant voltage controller 15 to a normal operating mode or a power-saving mode. The constant voltage power circuit 10 generates the constant voltage Vout in the normal operating mode, and the constant voltage power circuit 10 stops the operation thereof in the power-saving mode. As to the signal level of the power control signal PCS, low (L) means that the constant voltage power circuit 10 is set to the normal operating mode, and high (H) means that the constant voltage power circuit 10 is set to the power-saving mode.

The operating mode switch 17 sets each of operating modes of the reference voltage generator 13, constant voltage generator 14, and constant voltage controller 15 to switch each of biases supplied to the reference voltage generator 13, constant voltage generator 14, and constant voltage controller 15. For example, the operating mode switch 17 switches conduction state and non-conduction state of the line between the bias generator 11 and the first bias switch 161, the line between the ground GND and a bias terminal of the reference voltage generator 13, the line between the ground GND and the bias terminal of the constant voltage generator 14, and the line between the ground GND and a bias terminal of the constant voltage controller 15. The operating mode controller 18 generates an operating mode switch control signal SW3 that controls the operating mode switch 17 such that the turn-on and turn-off of the operating mode switch 17 are switched in accordance with the signal level corresponding to the power control signal PCS. That is, the operating mode controller 18 generates the operating mode switch control signal SW3 based on the power control signal PCS which sets each of the operating modes to a normal operating mode or a power-saving mode, and the operating mode switch 17 sets each of the operating modes in accordance with the operating mode switch control signal SW3.

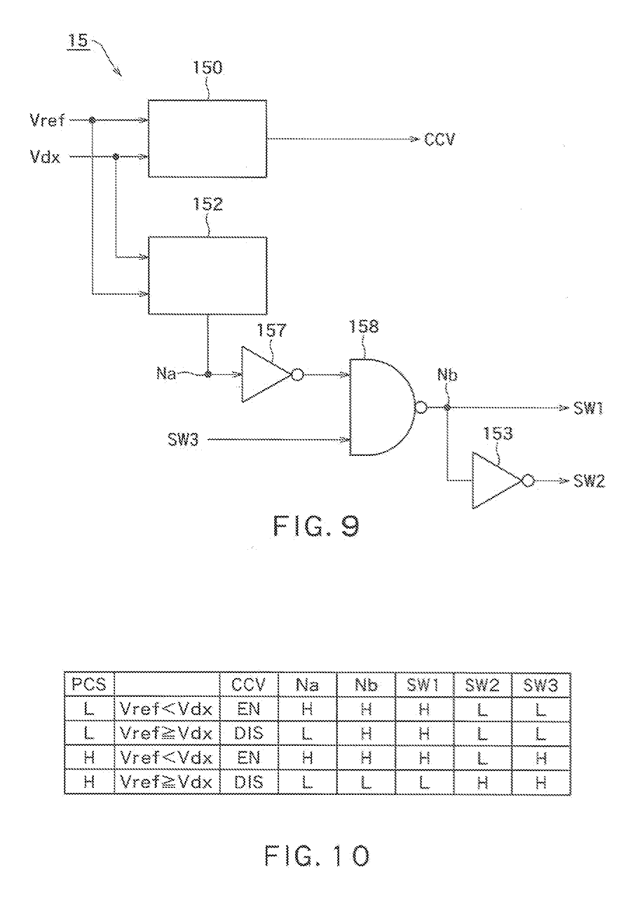

A configuration of the constant voltage controller 15 of the third embodiment will be described. FIG. 9 is a block diagram illustrating the configuration of the constant voltage controller 15 in FIG. 8 of the third embodiment.

The constant voltage controller 15 includes an inverter 157 and a NAND gate 158 in addition to the similar configuration to the first embodiment (that is, a control signal generator 150, a bias controller 152, and an inverter 153).

The inverter 157 inverts the signal level of the signal Na (that is, the output of the bias controller 152). The NAND gate 158 performs a NAND operation of the operating mode switch control signal SW3 and the output of the inverter 157. The output of the NAND gate 158 is the signal Nb. The inverter 153 inverts the signal Nb. That is, the signal level of the first switch control signal SW1 is equal to that of the signal Nb, whereas the signal level of the second switch control signal SW2 is inverse of that of the signal Nb (that is, that of the first switch control signal SW1).

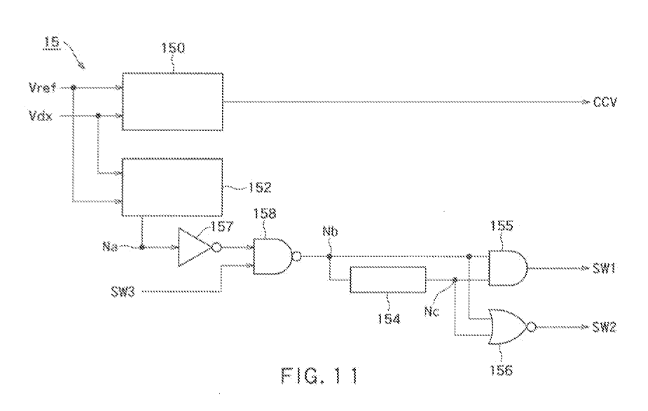

The signal levels of the power control signal PCS, constant voltage control signal CCV, first and second switch control signals SW1 and SW2, and operating mode switch control signal SW3 of the third embodiment will be described. FIG. 10 is a table illustrating the signal levels of the power control signal PCS, constant voltage control signal CCV, first and second switch control signals SW1 and SW2, and operating mode switch control signal SW3 of the third embodiment.

When the power control signal PCS is high (H), the signal level of the operating mode switch control signal SW3 becomes high (H) irrespective of the difference between the reference voltage Vref and the detected voltage Vdx. That is, the operating mode switch control signal SW3 (OFF) is generated. In this case, similarly to the first embodiment, the first and second switch control signals SW1 and SW2 that correspond to the difference between the reference voltage Vref and the detected voltage Vdx are generated. In other word, when receiving the power control signal PCS that sets the operating mode to the normal operating mode, the operating mode controller 18 generates the operating mode switch control signal SW3 such that the bias voltage Vbias is supplied to the reference voltage generator 13, the constant voltage generator 14, and the constant voltage controller 15.

On the other hand, when the power control signal PCS is low (L), the signal level of the operating mode switch control signal SW3 becomes low (L) irrespective of the difference between the reference voltage Vref and the detected voltage Vdx. That is, the operating mode switch control signal SW3 (ON) is generated. In this case, since the ground GND is connected to the bias terminals of the reference voltage generator 13, of the constant voltage generator 14, and of the constant voltage controller 15 by the operating mode switch 17, the bias voltage Vbias is not supplied. In other word, when receiving the power control signal PCS that sets the operating mode to the power-saving mode, the operating mode controller 18 generates the operating mode switch control signal SW3 such that the shut down voltage is supplied to the reference voltage generator 13, the constant voltage generator 14, and the constant voltage controller 15. This shut down voltage can shut down the constant voltage generator 14 as well as the reference voltage generator 13 and the constant voltage controller 15.

According to the third embodiment, the operating mode controller 18 sets the operating modes of the bias generator 11, reference voltage generator 13, constant voltage generator 14, and constant voltage controller 15 to the normal operating mode or the power-saving mode based on the power control signal PCS. In the power-saving mode, since the bias terminal of the bias generator 11 is connected to the ground GND, not only the constant voltage generator 14 but also the reference voltage generator 13 and the constant voltage controller 15 are shut down. Therefore, the power consumption of the constant voltage power circuit 10 can further be reduced than that of the first embodiment.

### Fourth Embodiment

A fourth embodiment will be described below. In the fourth embodiment, an example in which the power consumption of the constant voltage power circuit is further reduced than that of the second embodiment. The substantially same description as the third embodiment is omitted. Particularly, a configuration of a constant voltage power circuit 10 of the fourth embodiment is substantially identical to that of the third embodiment.

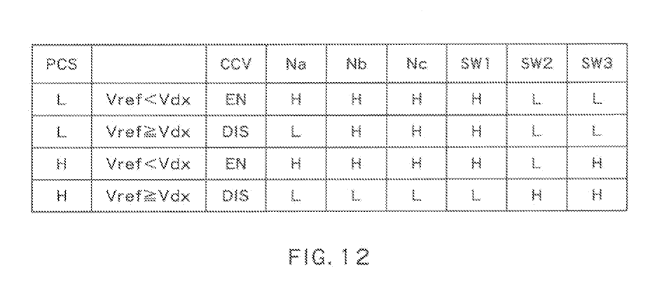

A configuration of a constant voltage controller 15 of the fourth embodiment will be described below. FIG. 11 is a block diagram illustrating the configuration of a constant voltage controller 15 in FIG. 8 of the fourth embodiment.

The constant voltage controller 15 includes the similar configuration to the third embodiment (that is, an inverter 157 and a NAND gate 158) in addition to the similar configuration to the second embodiment (that is, a control signal generator 150, a bias controller 152, an AND gate 155, and a NOR gate 156).

A delay circuit 154 delays the signal Nb by the predetermined delay time Δt. The AND gate 155 performs an AND operation of a signal Nc, which is the output of the delay circuit 154, and the signal Nb. The output of the AND gate 155 is the first switch control signal SW1. The NOR gate 156 performs a NOR operation of the signals Nb and Nc. The output of the NOR gate 156 is the second switch control signal SW2. The signal level of the first switch control signal SW1 is equal to those of the signals Nb and Nc, whereas the signal level of the second switch control signal SW2 is inverse of those of the signals Nb and Nc.

The signal levels of the power control signal PCS, constant voltage control signal CCV, first and second switch control signals SW1 and SW2, and operating mode switch control signal SW3 of the fourth embodiment will be described below. FIG. 12 is a table illustrating the signal levels of the power control signal PCS, constant voltage control signal CCV, first and second switch control signal SW1 and SW2, and operating mode switch control signal SW3 of the fourth embodiment.

When the power control signal PCS is high (H), the signal level of the operating mode switch control signal SW3 becomes high (H) irrespective of the difference between the reference voltage Vref and the detected voltage Vdx. That is, the operating mode switch control signal SW3 (OFF) is generated. In this case, similarly to the second embodiment, the first and second switch control signals SW1 and SW2 that correspond to the difference between the reference voltage Vref and the detected voltage Vdx are generated.

On the other hand, when the power control signal PCS is low (L), the signal level of the operating mode switch control signal SW3 becomes low (L) irrespective of the difference between the reference voltage Vref and the detected voltage Vdx. That is, the operating mode switch control signal SW3 (ON) is generated. In this case, since the ground GND is connected to the bias terminals of the reference voltage generator 13, of the constant voltage generator 14, and of the constant voltage controller 15 by the operating mode switch 17, the bias voltage Vbias is not supplied.

According to the fourth embodiment, the operating mode controller 18 sets the operating modes of the bias generator 11, reference voltage generator 13, constant voltage generator 14, and constant voltage controller 15 to the normal operating mode or the power-saving mode based on the power control signal PCS. In the power-saving mode, since the bias terminal of the bias generator 11 is connected to the ground GND, not only the constant voltage generator 14 but also the reference voltage generator 13 and the constant voltage controller 15 are shut down. Therefore, the power consumption of the constant voltage power circuit 10 can further be reduced than that of the second embodiment.

### Fifth Embodiment

A fifth embodiment will be described below. In the fifth embodiment, an example in which a semiconductor integrated circuit including the constant voltage power circuit 10 of any one of the first to fourth embodiments will be described.

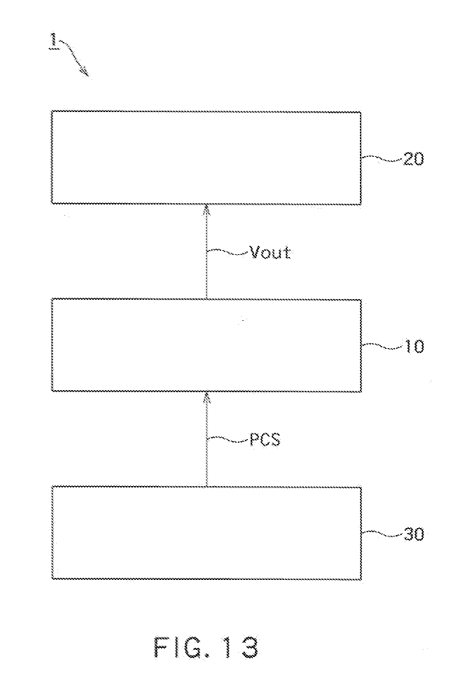

A semiconductor integrated circuit 1 of the fifth embodiment will be described below. FIG. 13 is a block diagram illustrating a configuration of the semiconductor integrated circuit 1 of the fifth embodiment.

The semiconductor integrated circuit 1 includes a constant voltage power circuit 10, a load 20, and a power manager 30. The power manager 30 generates the power control signal PCS that controls a power supply of the constant voltage power circuit 10. The constant voltage power circuit 10 generates the constant voltage Vout to be supplied to the load 20 in accordance with the power control signal PCS. The constant voltage power circuit 10 includes any one of the configurations of the first to fourth embodiments. The load 20 operates at the constant voltage Vout generated by the constant voltage power circuit 10. For example, the power manager 30 is a processor that manages the power supply of the semiconductor integrated circuit 1, and the load 20 is a shift register for a semiconductor storage device such as a flash memory.

According to the fifth embodiment, the power consumption of the constant voltage power circuit 10 can be reduced while the operation of the constant voltage power circuit 10 keeps normal functions. As a result, the supply of the constant voltage Vout to the load 20 is guaranteed and the power consumption of the semiconductor integrated circuit 1 is reduced.

In the above embodiments, by way of example, the second bias switch 162 switches whether the bias terminal of the constant voltage generator 14 is connected to the ground GND. However, the scope of the present invention is not limited to these embodiments. The invention can also be applied to the case that the second bias switch 162 switches whether the bias terminal of the constant voltage generator 14 is connected to a shut down voltage generator which generates the shut down voltage and supplies the shut down voltage to the constant voltage generator 14.

In the third and fourth embodiments, by way of example, the operating mode switch 17 switches whether the bias terminals of the bias generator 11, of the reference voltage generator 13, of the constant voltage generator 14, and of the constant voltage controller 15 are connected to the ground GND. However, the scope of the present invention is not limited to these embodiments. The invention can also be applied to the case that the operating mode switch 17 switches whether the bias generator 11, the reference voltage generator 13, the constant voltage generator 14, and the constant voltage controller 15 are connected to the shut down voltage generator.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A constant voltage power circuit comprising:
a bias generator generating a first bias voltage;
a reference voltage generator connected to the bias generator and generating a reference voltage based on the first bias voltage;
a constant voltage generator generating a constant voltage based on the first bias voltage and the reference voltage;
a bias switch switching a bias supplied to the constant voltage generator in accordance with a switch control signal controlling the bias switch; and
a constant voltage controller obtaining a detected voltage corresponding to the constant voltage or a power supply voltage, and generating a constant voltage control signal and the switch control signal in accordance with a difference between the reference voltage and the detected voltage, the constant voltage control signal setting an operating state of the constant voltage generator to an enable state or a disable state.

2. The circuit of claim 1, wherein
the constant voltage controller generates the constant voltage control signal setting the operating state to the enable state and the switch control signal connecting the constant voltage generator to the bias generator when the reference voltage is lower than the detected voltage, and
the constant voltage controller generates the constant voltage control signal setting the operating state to the disable state and the switch control signal supplying a second bias voltage shutting down the constant voltage generator when the reference voltage is equal to or higher than the detected voltage.

3. The circuit of claim 1, wherein the bias switch comprises:
a first bias switch operating to switch the first bias voltage to the constant voltage generator; and
a second bias switch operating to switch a second bias voltage shutting down the constant voltage generator.

4. The circuit of claim 2, wherein the bias switch comprises:
a first bias switch operating to switch the first bias voltage to the constant voltage generator; and
a second bias switch operating to switch a second bias voltage shutting down the constant voltage generator.

5. The circuit of claim 3, wherein the constant voltage controller comprises:
a control signal generator generating the constant voltage control signal;
a bias controller supplying a first switch control signal to the first bias switch, the first switch control signal having a first signal level corresponding to the difference between the reference voltage and the detected voltage; and
an inverter supplying a second switch control signal to the second bias switch, the second switch control signal having a second signal level being inverse of the first signal level,
wherein the first bias switch operates in accordance with the first switch control signal, and
the second bias switch operates in accordance with the second switch control signal.

6. The circuit of claim 4, wherein the constant voltage controller comprises:
a control signal generator generating the constant voltage control signal;
a bias controller supplying a first switch control signal to the first bias switch, the first switch control signal having a first signal level corresponding to the difference between the reference voltage and the detected voltage; and
an inverter supplying a second switch control signal to the second bias switch, the second switch control signal having a second signal level being inverse of the first signal level,
wherein the first bias switch operates in accordance with the first switch control signal, and
the second bias switch operates in accordance with the second switch control signal.

7. The circuit of claim 1, wherein
the constant voltage controller generates the switch control signal such that a second bias voltage shutting down the constant voltage generator is supplied to the constant voltage generator after cutting off the first bias voltage to the constant voltage generator in a case where the operating state is changed from the enable state to the disable state, and
the constant voltage controller generates the switch control signal such that the first bias voltage is supplied to the constant voltage generator after cutting off the second bias voltage to the constant voltage generator in a case where the operating state is changed from the disable state to the enable state.

8. The circuit of claim 2, wherein
the constant voltage controller generates the switch control signal such that the second bias voltage is supplied to the constant voltage generator after cutting off the first bias voltage to the constant voltage generator in a case where the operating state is changed from the enable state to the disable state, and
the constant voltage controller generates the switch control signal such that the first bias voltage is supplied to the constant voltage generator after cutting off the second bias voltage to the constant voltage generator in a case where the operating state is changed from the disable state to the enable state.

9. The circuit of claim 3, wherein
the constant voltage controller generates the switch control signal such that the second bias voltage is supplied to the constant voltage generator after cutting off the first bias voltage to the constant voltage generator in a case where the operating state is changed from the enable state to the disable state, and
the constant voltage controller generates the switch control signal such that the first bias voltage is supplied to the constant voltage generator after cutting off the second bias voltage to the constant voltage generator in a case where the operating state is changed from the disable state to the enable state.

10. The circuit of claim 9,
wherein the constant voltage controller comprises:
a control signal generator generating the constant voltage control signal;
a bias controller generating a signal having a first signal level corresponding to the difference between the reference voltage and the detected voltage;
a delay circuit delaying an output of the bias controller;
an AND gate performing an AND operation of an output of the bias controller and an output of the delay circuit, and outputting a first switch control signal having the first signal level; and
a NOR gate performing a NOR operation of the output of the bias controller and the output of the delay circuit, and outputting a second switch control signal having a second signal level being inverse of the first signal level,
wherein the first bias switch operates in accordance with the first switch control signal, and
the second bias switch operates in accordance with the second switch control signal.

11. The circuit of claim 10, wherein the delay circuit comprises even number of inverters.

12. The circuit of claim 10, wherein the delay circuit comprises at least one stage of an RC ladder type circuit.

13. The circuit of claim 1, further comprising:
an operating mode switch setting each of operating modes of the reference voltage generator, the constant voltage generator, and the constant voltage controller in accordance with an operating mode switch control signal; and
an operating mode controller generating the operating mode switch control signal based on a power control signal setting each of the operating modes to a normal operating mode or a power-saving mode.

14. The circuit of claim 13, wherein
the operating mode controller generates the operating mode switch control signal such that the first bias voltage is supplied to the reference voltage generator, the constant voltage generator, and the constant voltage controller when the operating mode controller receives the power control signal setting the operating mode to the normal operating mode, and
the operating mode controller generates the operating mode switch control signal such that a second bias voltage shutting down the reference voltage generator, the constant voltage generator, and the constant voltage controller is supplied to the reference voltage generator, the constant voltage generator, and the constant voltage controller when the operating mode controller receives the power control signal setting the operating mode to the power-saving mode.

15. A semiconductor integrated circuit comprising:
a load operating at a constant voltage;
a bias generator generating a first bias voltage;
a reference voltage generator connected to the bias generator and generating a reference voltage based on the first bias voltage;
a constant voltage generator generating the constant voltage based on the first bias voltage and the reference voltage;
a bias switch switching a bias supplied to the constant voltage generator in accordance with a switch control signal controlling the bias switch; and
a constant voltage controller obtaining a detected voltage corresponding to the constant voltage or a power supply voltage, and generating a constant voltage control signal and the switch control signal in accordance with a difference between the reference voltage and the detected voltage, the constant voltage control signal setting an operating state of the constant voltage generator to an enable state or a disable state.

16. The circuit of claim 15, wherein
the constant voltage controller generates the constant voltage control signal setting the operating state to the enable state and the switch control signal connecting the constant voltage generator to the bias generator when the reference voltage is lower than the detected voltage, and
the constant voltage controller generates the constant voltage control signal setting the operating state to the disable state and the switch control signal supplying a second bias voltage shutting down the constant voltage generator when the reference voltage is equal to or higher than the detected voltage.

17. The circuit of claim 15, wherein the bias switch comprises:
a first bias switch operating to switch the first bias voltage to the constant voltage generator; and
a second bias switch operating to switch a second bias voltage shutting down the constant voltage generator.

18. The circuit of claim 15, wherein
the constant voltage controller generates the switch control signal such that a second bias voltage shutting down the constant voltage generator is supplied to the constant voltage generator after cutting off the first bias voltage to the constant voltage generator in a case where the operating state is changed from the enable state to the disable state, and
the constant voltage controller generates the switch control signal such that the first bias voltage is supplied to the constant voltage generator after cutting off the second bias voltage to the constant voltage generator in a case where the operating state is changed from the disable state to the enable state.

19. The circuit of claim 15, further comprising:
an operating mode switch setting each of operating modes of the reference voltage generator, the constant voltage generator, and the constant voltage controller in accordance with an operating mode switch control signal; and
an operating mode controller generating the operating mode switch control signal based on a power control signal setting each of the operating modes to a normal operating mode or a power-saving mode.

20. The circuit of claim 19, wherein
the operating mode controller generates the operating mode switch control signal such that the first bias voltage is supplied to the reference voltage generator, the constant voltage generator, and the constant voltage controller when the operating mode controller receives the power control signal setting the operating mode to the normal operating mode, and
the operating mode controller generates the operating mode switch control signal such that a second bias voltage shutting down the reference voltage generator, the constant voltage generator, and the constant voltage controller is supplied to the reference voltage generator, the constant voltage generator, and the constant voltage controller when the operating mode controller receives the power control signal setting the operating mode to the power-saving mode.
